(19) United States
(12) Patent Application Publication
(10) Pub. No.: US 2019/0329490 A1
(43) Pub. Date: Oct. 31, 2019

(54) SYSTEM AND METHOD FOR PRODUCING A COMPONENT FROM A FIBER-REINFORCED PLASTIC MATERIAL

(71) Applicant: Airbus Operations GmbH, Hamburg (DE)

(72) Inventors: Volker ROBRECHT, Hamburg (DE); Peter LINDE, Hamburg (DE)

(21) Appl. No.: 16/394,353

(22) Filed: Apr. 25, 2019

(30) Foreign Application Priority Data
Apr. 27, 2018 (DE) 102018110232.1

(51) Int. Cl. B29C 64/165; B33Y 10/00; B33Y 30/00; B33Y 70/00; B29C 64/209; B29C 64/227; B29C 64/336; B33Y 40/00

(52) U.S. Cl. CPC B29C 64/165; B33Y 10/00; B33Y 30/00; B33Y 70/00; B29K 2105/08; B29C 64/227; B29C 64/336; B33Y 40/00; B29C 64/209

(57) ABSTRACT

A system for producing a component from a fiber-reinforced plastic material with a multi-axial motion device having a base, and a holding installation movable by the motion device. A material dispensing head is disposed on the holding installation. There is at least one fiber dispensing installation and at least one thermoplastic dispensing roll. At least one first feed line is coupled to the dispensing installation and at least one second feed line is coupled to the thermoplastic dispensing roll. The dispensing installation and the dispensing roll are disposed outside the motion device. The first and second feed lines are connected to the material dispensing head. The material dispensing head is configured to melt plastic material delivered by the dispensing roll and, when dispensing the fibers delivered by the dispensing installation, for coating the fibers with the melted plastic material or embedding the fibers in the plastic material.

### CROSS-REFERENCES TO RELATED APPLICATIONS

This application claims the benefit of the German patent application No. 10 2018 110 232.1 filed on Apr. 27, 2018, the entire disclosures of which are incorporated herein by way of reference.

### FIELD OF THE INVENTION

The invention relates to a system for producing a component from a fiber-reinforced plastic material, and to a method for producing a component from a fiber-reinforced plastic material.

### BACKGROUND OF THE INVENTION

Diverse variants of methods for producing three-dimensional components by additive processes exist in the prior art. These methods can depend on the type and the required characteristics of the components and, when required, can even integrate fiber reinforcements. For instance, methods by way of which fibers are braided and are subsequently embedded in a melted thermoplastic material or are coated with the latter such that a fiber-reinforced component is present upon cooling of the material are known.

Devices which provide one or a plurality of complex material dispensing installations in the form of a voluminous printing head on a robotic arm are known. This robotic arm is configured for positioning the printing head in an arbitrary manner in space. The printing head herein is specified for simultaneously dispensing material in the form of melted thermoplastics and fibers. To this end, various installations are integrated in the printing head. At least one installation for providing material, on the one hand, and at least one installation for conveying and optionally bringing into contact fibers and plastics, on the other hand, are provided.

It is furthermore known for a braiding installation to be integrated in such a printing head, the braiding installation producing a braided strand from individual fibers. The strand can subsequently be coated with the thermoplastics and be dispensed onto a substrate surface.

DE 10 2015 104 827 A1 shows a generative layered construction method for producing a three-dimensional fiber-reinforced object, and a corresponding device. In the case of the method, a multiplicity of layers from a pulverulent material are successively applied to a support installation, and each layer, prior to the application of the subsequent layer, is radiated by a laser beam or a particle beam selectively only in those regions that correspond to the object to be produced. A multiplicity of fibers which are set prior to the application of a layer of plastic material are provided.

### SUMMARY OF THE INVENTION

An arrangement of a complex printing head having a material supply and a braiding installation on a robotic arm can lead to various difficulties. A very powerful robotic arm is required by virtue of the high weight of a printing head of this type. The achievable accuracy is limited, in particular, also by virtue of the weight, since inertia-related movements can lead to set positions being overshot, which could be compensated for only by way of an even more powerful robotic arm. Moreover, the mass of the printing head decreases in operation, since material that is supplied on the printing head is being continuously dispensed.

An object of the invention accordingly lies in proposing a device for producing a component from a fiber-reinforced plastic material which is based on thermoplastics-coated fibers and permits a particularly high precision of the components, even in the case of comparatively complex shapes and comparatively large component dimensions and which is capable of being operated in an efficient manner.

A system is proposed having a multi-axial motion device having a base and a holding installation that is movable by the motion device; a material dispensing head that is disposed on the holding installation; at least one dispensing installation for dispensing fibers; at least one dispensing roll for thermoplastics; an at least one first feed line that is coupled to the dispensing installation; and at least one second feed line, coupled to the dispensing roll, for the thermoplastics, wherein the dispensing installation and the at least one dispensing roll are disposed outside the motion device, and wherein the material dispensing head is configured for melting plastic material that is delivered by the at least one dispensing roll and, when dispensing the fibers that are delivered by the at least one dispensing installation, for coating the fibers with the melted plastic material or embedding the fibers in the plastic material.

The multi-axial motion device having a base and a holding installation can be embodied, for example, by a robotic arm having a single articulation or multiple articulations. The base is to be considered as that portion of the motion device which is disposed so as to be fixed to a structure in a space. The base does not move and thus serves as a fixed point. Meanwhile, the holding installation could be a type of adapter, flange, or similar, to which the material dispensing head is rigidly fastened. The motion device is provided for guiding the material dispensing head precisely to predefined positions such that individual paths on a tool surface are provided with fibers and plastic material. The motion device can in particular be driven electrically, hydraulically or electro-hydraulically, and correspond to a commercially available industrial robot.

The dispensing roll can be a type of spool which supplies the plastic material. The plastic material can be embodied as a flat tape or a string. The dispensing roll is preferably mounted so as to be freely rotatable.

The dispensing installation for fibers in a simple variant can likewise be a type of spool onto which the fibers are wound. The fibers in this context are reinforcement fibers or functional fibers which do not primarily serve for reinforcing the component to be produced. This could include, for instance, glass fibers for optical applications, or metallic wires.

The material dispensing head is that part of the system that actually applies material to a substrate or a molding tool, respectively. To this end, plastic material which emanates from the at least one dispensing roll is melted. The melted plastic material then coats the fibers dispensed by the material dispensing head immediately prior to or during the dispensing procedure. This can particularly preferably be carried out by means of a nozzle in which both material flows are converged and dispensed.

The at least one first feed line and the at least one second feed line are to be particularly highlighted, the feed lines permitting protected conveying both of the plastic material from the at least one dispensing roll as well as of the fibers of the at least one dispensing installation into the material dispensing head. The material dispensing head can furthermore have a conveying installation which serves for conveying the plastic material and the fibers.

The system according to the invention can consequently dispense with large inert masses on the motion device and instead use a rather small, compact material dispensing head. The function of supplying, melting and providing in an orderly manner is carried out in a stationary manner. On account thereof, not only the required power of the motion device is reduced as compared to the variant mentioned above, but the precision when dispensing the material is also significantly increased by way of a consistently low inert mass of the material dispensing head.

One particularly advantageous embodiment additionally has a cooling installation which is disposed between the at least one second feed line and the material dispensing head or on an end of the at least one second feed line so as to be directly in front of the material dispensing head, and cools at least one first inlet for thermoplastics. The cooling installation can have an interior space and be configured for carrying out cooling of the interior space. The at least one second feed line can extend through the interior space or be connected to the latter in such a manner that the plastic material guided through the at least one feed line must pass through the interior space so as to reach into the material dispensing head. It can be prevented on account thereof that heat of an installation for melting the plastic material leads to the second feed line being heated, which otherwise could lead to premature melting of plastic material, in particular in the proximity of the material dispensing head, and on account thereof could impede the functioning of the material dispensing head.

One further preferred embodiment has a braiding installation for braiding fibers so as to form a strand, the braiding installation being embodied so as to be external to the material dispensing head, wherein the strand is guided into the at least one first feed line. The braiding installation can process a plurality of fibers or fiber strands so as to form a braided strand which is guided by way of the at least one first feed line having the material dispensing head. Consequently, complex braiding of fibers so as to form a strand in the material dispensing head is also not necessary such that significantly more complex braiding installations having many spools and a complex mechanism can be provided so as to supply the material dispensing head with a braided strand of fibers.

It is to be pointed out that the braided strand does not mandatorily have to be embodied in a tubular manner but can also be embodied as a flat strand. Independently of the embodiment of the braided strand, the at least one first feed line can nevertheless have a circular cross section through which the braided strand can be conveyed. The braided strand, for instance with the aid of a mandrel or a similar installation for the conveyance through the at least one first feed line, could be continually formed to a tubular structure which after being transported into the material dispensing head, or after leaving the first feed line, respectively, is restored to the original shape.

In the case of one advantageous embodiment a dispensing roll for a strand of non-braided fibers can be provided. The strand can be embodied as a woven fabric or as a strand of parallel fibers. The parallel fibers could be knitted so as to simplify conveying.

In one preferred embodiment the motion installation has a robotic arm. As has already been mentioned above, a robotic arm having a comparatively low power can suffice, since the inert mass of the material dispensing head is comparatively minor.

In one further advantageous embodiment the motion installation has a multi-axis linear system. This could be expedient in particular in the production of planar components in a large format which always have to be produced on a planar tool surface. The precision can be very high on account of such a linear system, and very high production rates can likewise be implemented. The movements achievable by large-format linear systems would require relatively large robotic arms with multiple articulations. However, it could also be provided that a platform which is at least movable along at least one axis is used, the platform supporting the base of the motion device, the dispensing installation, and the at least one dispensing roll.

In one particularly preferred embodiment the at least one second feed line is produced from a transparent material. On account thereof, a user can check directly whether the material flow, in the form of the plastic material strand, to the material dispensing head exists without any impediment. It could be expedient for a transparent tube from a plastic material to be used.

In one further advantageous embodiment, the system can have at least one conveying installation which is placed outside the material dispensing head and is configured for conveying the thermoplastics to the material dispensing head. The handling of the plastic material in the material dispensing head can be facilitated on account thereof. It is to be pointed out in this context that the plastic material preferably has such a strength that the plastic material can be readily transported through the respective feed line to the material dispensing head. Meanwhile, the dimensions of the feed line and of the plastic material are to be mutually adapted in such a manner that the plastic material can easily slide through the feed line. The difference between the diameters of the plastic material and a cavity of the feed line should however not be so large that the material backs up when conveyed, moves toward the walls of the cavity in waves and is wedged on the walls.

The at least one dispensing installation can have fibers which are selected from a group of fibers, the group including:

carbon fibers,

glass fibers,

aramid fibers,

conductive liquid fibers, and

metal wires.

Carbon fibers, glass fibers, and aramid fibers can primarily be used as reinforcement fibers. The glass fibers could also be embodied such that the glass fibers are capable of being used for optical purposes, for instance for an illumination or for structural health monitoring. Conductive coated fibers and metal wires are capable of being used, in particular, for conducting electric current, or likewise for structural health monitoring.

Apart from the use of a single dispensing installation, a plurality of dispensing installations which also transport dissimilar fibers or fiber-like materials to the material dispensing head can also be provided. The combination of carbon fibers and wires could in particular lead to the integration of additional functions in a component from a fiber-composite material. It is to be noted here that wires do not necessarily have to be braided but can also be embedded in the remaining material as individual wires or strands.

The thermoplastics could preferably be a high-strength plastic material which is suitable for the production of structural components of a vehicle. It could be expedient for polyether ketone ketone (PEKK) or polyether ether ketone (PEEK) to be used. These materials are distinguished in that they have excellent properties in combination with reinforcement fibers such as, for instance, carbon fibers. Structural components of high strength are capable of being produced therewith, and repairs by plastic welding are at the same time capable of being readily carried out. The system according to the invention herein would not only be expedient for the original production of a structural component but also for carrying out repairs on specific structural components of a vehicle when the latter is situated at a remote location. Consequently, a data set pertaining to the geometric shape of the respective structural component could be transmitted to the system by way of a corresponding data connection, in order for the required spare part to be produced from the data set.

The invention furthermore relates to a method for producing a component, comprising the following continuous steps, which are preferably carried out simultaneously, of conveying fibers, provided outside the motion device, through at least one first feed line into a material dispensing head that is disposed on the motion device; conveying plastic material from at least one dispensing roll, disposed outside a motion device, through at least one second feed line to the material dispensing head; heating the plastic material and the fibers; dispensing a mixture of melted plastic material and fibers from a nozzle; and moving the motion device for successively applying the mixture to a molding tool for configuring the component.

The method can furthermore comprises the step of cooling at least one first inlet for thermoplastics. On account thereof, a thermal input into the corresponding feed lines for the plastic material can be prevented.

### BRIEF DESCRIPTION OF THE DRAWINGS

Further features, advantages, and potential applications of the present invention are derived from the description hereunder of the exemplary embodiments and the figures. All of the features which are described and/or are illustrated pictorially form, individually and in any combination, the subject matter of the invention also regardless of their inclusion in the individual claims or the dependency references thereof. Furthermore, in the figures, the same reference signs refer to identical or similar objects.

FIG. 1 shows a three-dimensional illustration of a system according to the invention for producing a component from a fiber-reinforced plastic material.

FIG. 2 shows a schematic illustration of the material dispensing head.

### DETAILED DESCRIPTION OF THE PREFERRED EMBODIMENTS

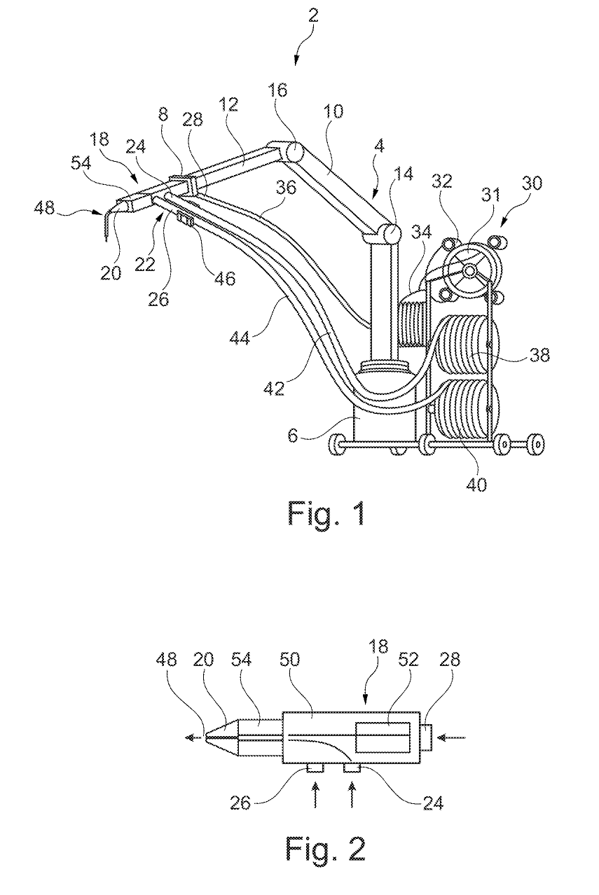

FIG. 1 shows a system 2 in a three-dimensional illustration. The system 2 has a multi-axial motion device 4 which has a base 6 and a holding installation 8 that is movable by the motion device 4. The motion device 4, in an exemplary manner, is embodied as a robotic arm which has two articulated arms 10 and 12 which are connected to one another by joints 14 and 16. The joints 14 and 16 can in particular be ball joints so that the holding installation 8 is movable in an arbitrary manner in all spatial directions.

The holding installation 8 supports a material dispensing head 18 which has a nozzle 20 and a series of material inlets 22. The material inlets 22 comprise, for instance, a first inlet 24 for thermoplastics, a second inlet 26 for thermoplastics, and a fiber inlet 28 for fibers.

A dispensing installation 30 which in an exemplary manner has a braiding installation 31 is disposed beside the base 6. The dispensing installation 30 possesses four rollers 32 for dispensing fibers which are mutually braided by way of a mechanism (not illustrated here). A braided strand 34 of fibers is thus provided, the braided strand 34 by way of a first feed line 36 is guided by way of the fiber inlet 28 into the material dispensing head 18. A first conveying installation (not illustrated) that is disposed in the material dispensing head 18 is provided for continuously transporting the strand 34 by way of the first feed line 36 into the material dispensing head 18, and for dispensing the strand 34 from the nozzle 20.

Two dispensing rolls 38 and 40 which can dispense the thermoplastics and can in each case deliver the latter to the material dispensing head 18 by way of a second feed line 42 or 44 are furthermore provided. The second feed lines 42 and 44 are connected to the first inlet 24 and the second inlet 26. The thermoplastics can comprise a plastic material that is suitable for the component to be produced; polyether ether ketone and polyether ketone ketone could be expedient for implementing high-strength structural components.

A cooling installation 46 through which the two feed lines 42 and 44 extend is disposed on the inlets 24 and 26 and so as to be in the direct proximity of the material dispensing head 18. It can be prevented on account thereof that heat of a heating installation that is integrated in the material dispensing head 18 makes its way into the second feed lines 42 and 44 and leads to plastic material being already melted therein. The cooling installation 46 can consequently enhance the safety and reliability of the system.

The material dispensing head 18 is specified for generating a dispensing material flow 48 from a flow of fibers 34 and at least one flow of melted plastic material, the dispensing material flow 48 substantially including a mixture of the fibers and the plastic material. The material dispensing head 18, on account of the freely movable robotic arm 4, can sweep practically any arbitrary areas in order for a fiber-reinforced component, or a component equipped with embedded fibers, respectively, to be produced. The absence of all material dispensing installations for the plastic material and the fibers directly on the material dispensing head 18 leads to a very manageable size of the material dispensing head 18 which, on account thereof, can also be better maneuvered into tight spaces and consequently can also implement complex shapes.

FIG. 2 shows a schematic construction of the material dispensing head 18 in a sectional illustration. The material dispensing head 18 can have a housing 50, the first inlet 24, the second inlet 26, and the fiber inlet 28 being disposed on the housing 50. In an exemplary manner, a conveying installation 52 is disposed in the housing 50 and is configured for conveying fibers from the fiber inlet 28 to the nozzle 20. At the same time, the plastic material from the first and second inlet 24 and 26 is directed toward the nozzle 20. A heating installation 54 which is configured for melting the plastic material is situated directly ahead of the nozzle 20. The flow 48 from fibers and plastic material results on account thereof.

It should furthermore be noted that features which have been described in the context of one of the above embodiment examples can also be used in combination with other features of other embodiment examples described above.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise,” “having” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for producing a component from a fiber-reinforced plastic material, comprising:
a multi-axial motion device having a base and a holding installation movable by the motion device;
a material dispensing head disposed on the holding installation;
at least one dispensing installation for dispensing fibers;
at least one dispensing roll for thermoplastics;
at least one first feed line coupled to the dispensing installation; and
at least one second feed line, coupled to the at least one dispensing roll, for the thermoplastics,
wherein the at least one dispensing installation and the at least one dispensing roll are disposed outside the motion device, and
wherein the material dispensing head is configured for melting plastic material delivered by the at least one dispensing roll and, when dispensing the fibers delivered by the at least one dispensing installation, for coating said fibers with melted plastic material or embedding said fibers in said plastic material.

2. The system according to claim 1, furthermore having a cooling installation disposed between the at least one second feed line and the material dispensing head, or on an end of the at least one second feed line, so as to be directly in front of the material dispensing head, and to cool at least one first inlet for the thermoplastics.

3. The system according to claim 1, furthermore having at least one braiding installation for braiding the fibers so as to form a strand, said braiding installation being disposed outside the motion device and embodied to be external to the material dispensing head, wherein the strand is guided into the at least one first feed line.

4. The system according to claim 1, furthermore having a dispensing roll for a strand of non-braided fibers.

5. The system according to claim 1, wherein the motion device has a robotic arm.

6. The system according to claim 1, wherein the motion device has a multi-axis linear system.

7. The system according to claim 1, wherein the at least one second feed line is produced from a transparent material.

8. The system according to claim 1, furthermore having at least one conveying installation placed outside the material dispensing head and being configured for conveying the thermoplastics through the at least one second feed line to the material dispensing head.

9. The system according to claim 1, wherein the at least one dispensing installation has the fibers selected from a group of fibers, said group including:
carbon fibers,
glass fibers,
aramid fibers,
conductively coated fibers, and
metal wires.

10. The system according to claim 1, wherein at least one of the at least one dispensing rolls contains plastic material which comprises polyether ketone ketone (PEKK) or polyether ether ketone (PEEK).

11. A method for producing a component, comprising the following continuous steps:
conveying fibers, provided outside a motion device, through at least one first feed line into a material dispensing head that is disposed on the motion device;
conveying plastic material from at least one dispensing roll, disposed outside the motion device, through at least one second feed line to the material dispensing head;
heating the plastic material and the fibers;
dispensing a mixture of melted plastic material and fibers from a nozzle; and
moving the motion device for successively applying the mixture to a molding tool for configuring the component.

12. The method according to claim 11, wherein the steps are carried out simultaneously.

13. The method according to claim 11, furthermore comprising the step of
cooling at least one first inlet of the material dispensing head for thermoplastics.
